(19) United States
(12) Patent Application Publication
(10) Pub. No.: US 2011/0034194 A1
(43) Pub. Date: Feb. 10, 2011

(54) LOCAL WIRELESS COMMUNICATION SYSTEM AND METHOD FOR ADAPTIVE CHANNEL SELECTION OF SENSOR SYSTEMS

(75) Inventors: Sang-Min HAN, Gyeonggi-do (KR); Jong-Sik Lim, Daejeon (KR); Dal Ahn, Chungcheongnam-do (KR); Won-Sang Yoon, Seoul (KR); Young-Sik Kim, Seoul (KR)

Correspondence Address: RABIN & Berdo, PC, 1101 14TH STREET, NW, SUITE 500, WASHINGTON, DC, 20005, US

(73) Assignee: Soonchunhyang University Industry Academy Cooperation Foundation, Chungcheongnam-do (KR)

(21) Appl. No.: 12/636,688

(22) Filed: Dec. 11, 2009

(30) Foreign Application Priority Data
Aug. 4, 2009 (KR) 10-2009-0071527

(51) Int. Cl. H04B 7/005

(52) U.S. Cl. 455/509

(57) ABSTRACT

An apparatus for performing a local wireless communication using a frequency band. At least a part of the frequency band is divided into a plurality of channels. The apparatus includes a plurality of sensors, each sensor scanning each channel to identify whether each channel is used or not, selecting an unused channel as a data transmission channel, and transmitting data through the unused data transmission channel. The apparatus further includes at least one hub receiving and processing the data transmitted from each sensor through each corresponding data transmission channel.

This non-provisional application claims priority under 35 U.S.C. §119(a) on Patent Application No. 10-2009-0071527 filed in Republic of Korea on Aug. 4, 2009, the entire contents of which are hereby incorporated by reference.

### BACKGROUND OF THE INVENTION

1. Technical Field

The present invention is directed to a wireless communication field, and more specifically to a local wireless communication system and method for channel selection of sensor systems, which may secure a communication channel in a given frequency band by using a spectrum-sensing method.

2. Related Art

In recent years, wireless communication systems have rapidly grown up owing to the commercialization of mobile telecommunication and technological convergence.

Unlike long-haul telecommunication technologies such as satellite or mobile communications, local wireless access technologies, especially RF/Microwave systems, are different from an image of current simple up/down conversion systems and pursue technological innovation mainly employing wideband, low-power consumption, and efficient distribution of frequency resources.

A good example of the wideband technology is UWB (Ultra Wideband) that has been enjoying its frame as one of highly-ranked wireless technologies for the last ten years.

Since a standard frequency band for UWB was assigned by U.S. FCC, the research and development has been focusing on both IEEE 802.15.3a associated with HR (High-Rate) UWB technologies and IEEE 802.15.4a associated with LR (Low-Rate) UWB.

Wideband technologies in the field of RF/Microwave generally have been treated for simple increment of the bandwidth for system applications. Thus, it has been overlooked for technical environments as a key to technological success, may be achieved only by researching circuit technologies in point of view of systemic considerations.

Representative HR-UWB camps are the MBOA (multiband OFDM Alliance), which increases a signal bandwidth of OFDM (Orthogonal Frequency Division Multiplexing) as much as necessary for high-rate communications, and DS-CDMA that spreads and uses the entirety of 2 GHz frequency band. In particular, IEEE 802.15.4a standard for LR-UWB is now excluded from next generation USN (Ubiquitous Sensor Network) terminal candidate in a standard competition, because it was shifted to a high-capability, high-cost standard based on IR (Impulse Radio) by high-accuracy additional functions.

Second, RF/Analog circuit-related technologies have been rapidly developed for the last twenty years by overcoming problems with current wireless terminals such as bulky size and large power consumption thanks to the integration technologies.

At the same time, circuit and system design technologies for low-power applications are required for BioRF, RF Sensor Node, and so on from the demand of recent diversified system environments and circuit technologies.

Pico (10⁻¹²) watt RF transceiver and network technologies have been co-researched for sensor nodes in BWRC (Berkeley Wireless Research Center) of UCB (University of California at Berkeley), a representative of the lower power RF technology research organization.

This project named “PicoRadio” partially enjoyed a success in developing low-power RF devices using MEMS and energy scavenging technology that collects energy from natural sources, however, such a success is still limited in developing a few devices and evaluating the possibility of energy scavenging technology.

Accordingly, a new project called “pJoule” has been launched to continue researching low-power, high-efficient systems.

Third, “cognitive radio (CR)” system technology, originating from a point of view of efficient reuse of limited frequency resources, primarily focuses on system hardware in which a terminal determines whether to use a spectrum of a wireless broadcasting channel to dynamically allocated a channel.

This technology can save costs as well as effectively operate wireless channels by efficient reuse of a frequency resource that is considered as the only medium in wireless communications.

Further, it has an advantage of the capability of developing a new wireless application using a spectrum sensing technology.

However, most of spectrum sensing technologies, which are core technologies of a CR system and have been suggested and studied in IEEE 802.22 standard, have a procedure of down-converting a signal received by a terminal to a baseband to identify whether there is a valid signal on a channel by a digital processor or not.

It has some demerits like long processing time and high energy consumption.

Meanwhile, the GEDC (Georgia Electronic Design Center) of Georgia Tech., USA, which is the only institute with spectrum sensing technology in RF Front-End, suggested a technology of identifying whether a spectrum is used or not at relatively high speed through a dual loop process of “Coarse sensing” and “Fine Sensing”.

In Korea, it has been attempted by ETRI, Samsung Electro-Mechanics together with a professor group of GEDC (J. Lasker et al.) to introduce a dual loop technology to CR systems.

Because of adopting precise and accurate dual evaluation, the spectrum sensing technology of GEDC is appropriate for relatively complicated terminal environments requiring high-cost, high-class services, but not for local low-power small systems such as USNs.

### SUMMARY

According to an aspect of the present invention, there is provided a local wireless communication system and method that may secure an unused channel in a given bandwidth over a local communication network by a high-speed spectrum sensing method in a RF system, thereby allowing for low power communications.

According to another aspect of the present invention, there is provided a local wireless communication system and method that may dynamically secure a communication frequency channel by a sensor node over a local communication network, thereby minimizing interference in an unlicensed frequency band.

In an aspect of the present invention, a local wireless communication system includes: a plurality of sensors, each sensor dividing at least part of a frequency band into a plurality of channels, spectrum-sensing a signal received at the frequency band for each of the plurality of channels to identify available one among the plurality of channels, and transmitting modulated data through the channel identified to be available; and at least one hub performing local wireless communications with the plurality of sensors at the frequency band, the hub receiving and processing the data transmitted from the sensor through a corresponding channel of the frequency band.

The sensor may include a frequency-variable detecting unit that detects a channel signal corresponding to a resonance frequency generated according to a control signal among signals received at the frequency band.

The frequency-variable detecting unit may include a resonator that variably generates a resonant frequency generated according to the control signal, and a signal detector that detects each channel signal of the frequency band corresponding to a resonance frequency generated by the resonator.

The signal detector may be a varactor diode that detects a signal carried on the frequency channel according to a variable resonance frequency of the resonator.

Upon data modulation through the channel identified to be available, the sensor may employ OOK (On Off Keying) or ASK (Amplitude Shift Keying) as its modulation scheme.

The sensor may further include a controller that may generate a control signal to perform spectrum-sensing on signals received on the frequency band for each and every channel when a timer indicates a predetermined transmission time.

The hub may filter a signal received at the frequency band for each channel, and analyze a header of packet data for each channel to receive and process the packet data when the packet data is identified to have a designated code.

In another aspect of the present invention, a local wireless communication method in which at least one hub performs local wireless communications with a plurality of sensors at a predetermined frequency band, includes: dividing at least part of the frequency band into a plurality of channels; scanning a signal received at the frequency band for each channel by a spectrum-sensing method to identify whether the channel is used or not, when the sensor reaches any assigned time when data is subjected to transmission; selecting an unused channel as a data transmission channel when it is identified there is the unused channel; and transmitting modulated data to the hub through the data transmission channel.

Said identifying whether the channel is used or not may include generating a predetermined control signal, receiving the control signal to generate a corresponding resonant frequency, and detecting a channel signal corresponding to the generated resonant frequency.

The control signal may be a DC (Direct Current) signal for controlling the capacitance C of a variable condenser.

Said detecting the channel signal may include detecting a signal carried on the frequency channel according to a variable resonance frequency of the resonator by the control signal.

The local wireless communication method may further include filtering a signal received by the hub at the frequency band for each channel; and analyzing a header of packet data for each channel to receive and process the packet data when the packet data is identified to have a designated code.

According to the present invention, an unused channel in a given bandwidth over a local communication network may be secured by a high-speed spectrum sensing method in a RF bandwidth, thereby implementing a low power sensor that may achieve high-speed frequency selection.

Further, a communication frequency channel may be dynamically secured by a sensor node over a local communication network, thereby minimizing interference in an unlicensed frequency band.

### BRIEF DESCRIPTION OF THE DRAWINGS

The implementation of this document will be described in detail with reference to the following drawings in which like numerals refer to like elements.

FIG. 1 is a view schematically illustrating a local wireless communication system according to an exemplary embodiment;

FIG. 2 is a view illustrating a concept of band and channel according to an exemplary embodiment;

FIG. 3 is a block diagram illustrating a detailed structure of a sensor according to an exemplary embodiment;

FIG. 4 is a block diagram illustrating a detailed structure of a hub according to an exemplary embodiment;

FIG. 5 is a graph illustrating an output signal depending on a variation to a resonance frequency by parameter sweep for variable detection of a sensor according to an exemplary embodiment of the present invention.

FIG. 6 is a view illustrating a structure of a transmission packet according to an exemplary embodiment;

FIG. 7 is a flowchart illustrating a data transmission procedure performed by a sensor according to an exemplary embodiment; and

FIG. 8 is a flowchart illustrating a data receiving procedure performed by a hub according to an exemplary embodiment of the present invention.

### DETAILED DESCRIPTION

According to the present invention, there is suggested a local wireless communication system and method that uses spectrum sensing technology to secure a channel for local wireless communication between each of a plurality of sensors and a hub over a sensor network including the sensors and the hub.

It should be noted that each communication subject in the local wireless communication system according to the present invention is not limited to the hub and the sensors, but may include any devices that may perform communications. Hereinafter, communication between a hub and each of sensors will be described as exemplary embodiments.

In an exemplary embodiment, a predefined bandwidth is divided into a plurality of channels. The plurality of channels is scanned to find out unused channels for the purpose of communication.

In this exemplary embodiment, particularly when a sensor intends to periodically or non-periodically transmit to a hub, an information collecting device, information such as body information including the heart rate and body temperature collected by a temperature sensor or WBAN (Wireless Body Area Network), positional information, building monitoring information or the like, the sensor spontaneously finds out a channel available within a band and transmits the information over the channel.

The sensor determines whether to use the channels from the received signals through a frequency-variable receiving type channel envelop rectifying circuit (hereinafter, simply referred to as “frequency-variable detecting unit”). This allows for high speed spectrum sensing with reduced cost and power consumption.

In particular, the frequency-variable detecting unit, which determines whether to use a channel, operates only when there is any input signal carried over a frequency channel corresponding thereto. By doing so, power consumption of the sensor may be reduced.

Hereinafter, exemplary embodiments will be described in greater detail with reference to accompanying drawings.

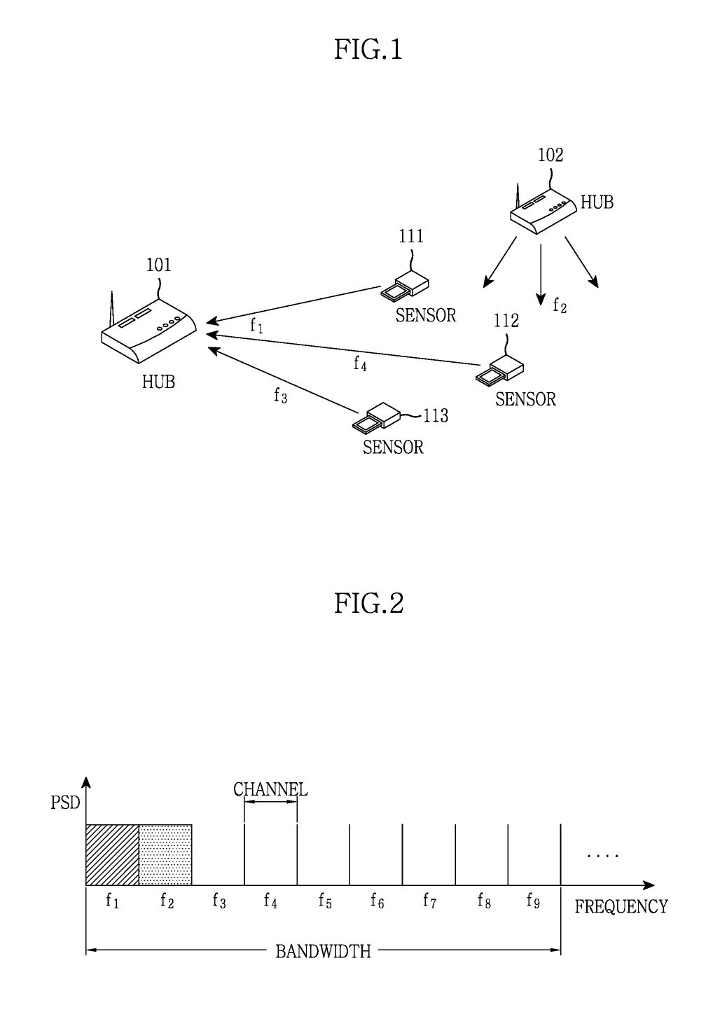

FIG. 1 is a view schematically illustrating a local wireless communication system according to an exemplary embodiment of the present invention. Referring to FIG. 1, the local wireless communication system may include a plurality of hubs 101 and 102, and a plurality of sensors 111, 112, and 113.

The hub 101 is located near the sensors 111, 112, and 113 (for example, on the order of 10 m to 30 m) to communicate with each of the sensors 111, 112, and 113, so that information collected by the sensors 111, 112, and 113 may be periodically or non-periodically transmitted to the hub 101.

Each of the sensors 111, 112, and 113 should use a frequency channel different from that of the others to avoid frequency interference and carry out normal communications when the sensors 111, 112, and 113 simultaneously transmit their signals. Accordingly, when the sensors 111 and 112 use frequency channels f1 and f4, respectively, and the hub 102 uses frequency channel f2, the other sensor 113 should use the remaining frequency channel f3 currently unused for data transmission.

FIG. 2 is a view schematically illustrating a band and channels used in an exemplary embodiment of the present invention. Referring to FIG. 2, the hubs 101 and 102 and the sensors 111, 112, and 113 as shown in FIG. 1 may use a predefined frequency band within a local area.

In this exemplary embodiment, the band may be an unlicensed frequency band such as ISM (Industrial Scientific Medical) band.

The unlicensed frequency band is primarily allocated for low-power wireless devices that do not require any permission for use. Communication devices employing this frequency band may be used only under the condition of approving interference with ISM devices. Accordingly, a communication device may conduct normal communications over an unlicensed frequency band only when the unlicensed frequency band (or a channel included in the band) is not occupied by other communication devices.

As shown in FIG. 2, the predefined band may be divided into a plurality of channels. Each communication device may select a certain one among the plurality of channels and transmit data through the selected channel over the local communication network. As described above, since each device fails to perform normal communications when using the same frequency channel as that of the others, each channel is subjected to a spectrum sensing in order to determine whether the channel is used or not and then secure any available frequency channel. In this exemplary embodiment, frequency sensing is implemented by a frequency-variable detecting unit, whose detailed descriptions will be made later.

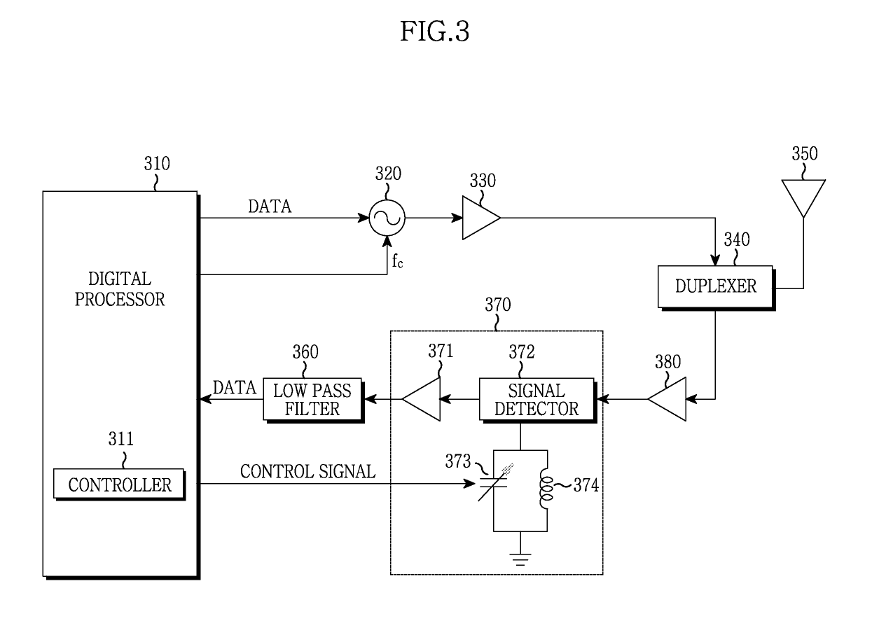

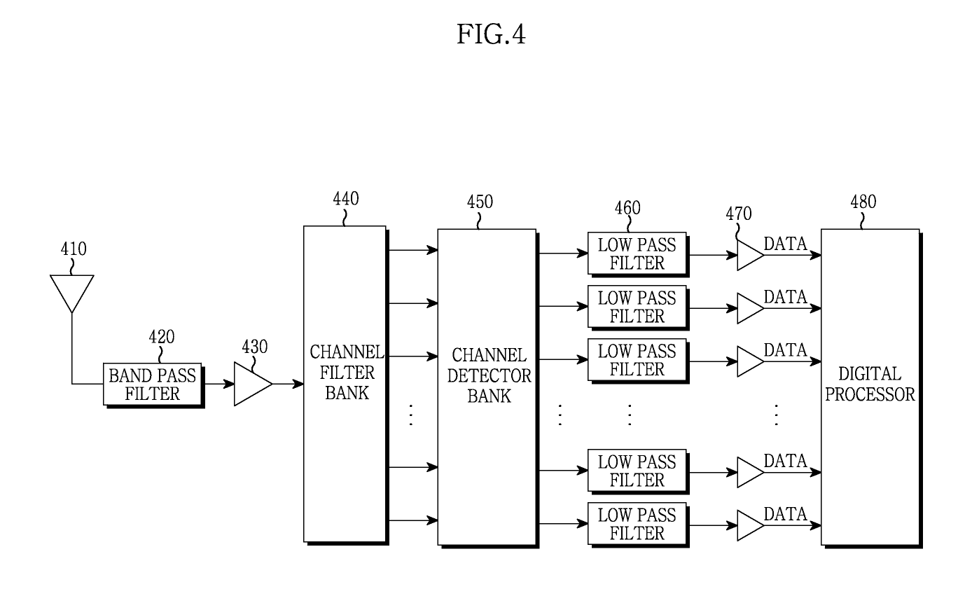

The structures of the sensor and hub according to exemplary embodiments will now be described in more detail with reference to FIGS. 3 and 4.

FIG. 3 is a block diagram illustrating a detailed structure of a sensor according to an exemplary embodiment of the present invention.

Referring to FIG. 3, the sensor may include a digital processor 310, an oscillator 320, amplifiers 330 and 380, a duplexer 340, an antenna 350, a frequency-variable detecting unit 370, and a LPF (Low Pass Filter) 360. The digital processor 310 may include a controller 311 that generates various control signals. The frequency-variable detecting unit 370 may include an amplifier 371, a signal detector 372, a variable condenser 373, and a coil 374.

The sensor periodically or non-periodically wakes up to transmit various types of sensed information (for example, temperature information, body information such as the heart rate and body temperature transmitted over a WBAN (Wireless Body Area Network), positional information, building monitoring information or the like) to a hub. For this case, the sensor may include a timer (not shown) to determine a time point that the sensor secures a transmission channel and transmits information through the secured transmission channel.

More specifically, upon reaching the time point, the controller 311 supplies a control signal to the frequency-variable detecting unit 370. The control signal, which may be a DC (Direct Current) signal, is supplied to the variable condenser 373 included in a resonator (that is, an LC circuit)—the resonator belongs to the frequency-variable detecting unit 370 and is composed of the variable condenser 373 and the coil 374. The control signal causes a resonance frequency in the resonator. The signal detector 372 detects a channel signal corresponding to the resonance frequency.

That is, the controller 311 sequentially adjusts the magnitude of a DC voltage of a control signal generated therefrom to control the capacitance C of the variable condenser 373 included in the frequency-variable detecting unit 370, the resonator generates a resonant frequency according to the capacitance C, and the signal detector 372 sequentially rectifies all channels in a band by the resonant frequency until a channel is secured.

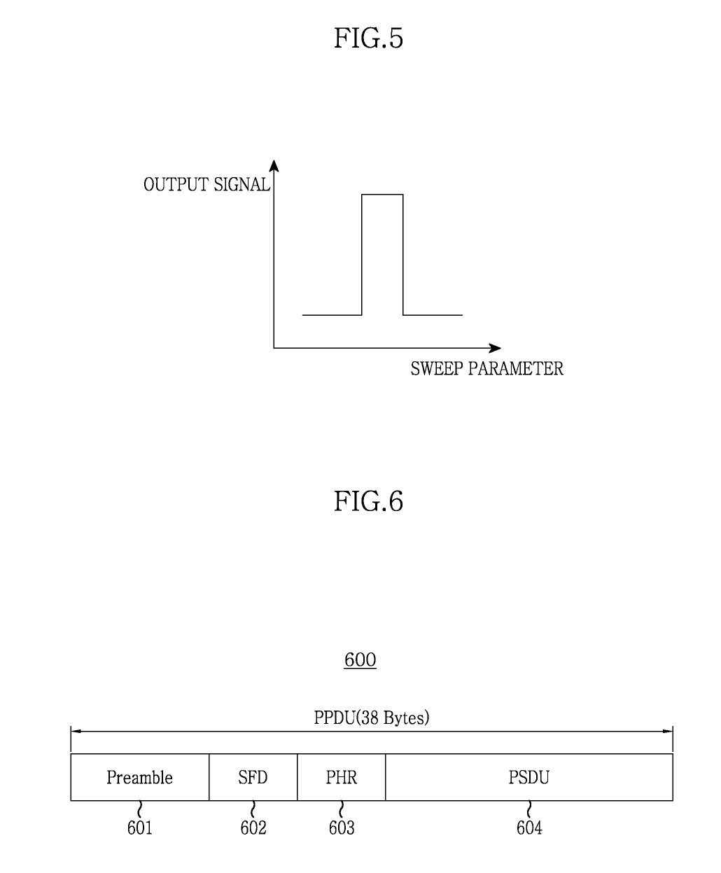

The signal detector 372, which may be a capacitance-variable element such as a varactor diode, detects a signal carried on the frequency channel according to a variable resonance frequency of the resonator. The detected signal is inserted to the digital processor 310 via the amplifier 371 and the LPF 360. The spectrum-sensed signal has a constant magnitude depending on whether or not there is a signal received on the channel, as shown in FIG. 5.

FIG. 5 is a graph illustrating an output signal depending on a variation to a resonant frequency by parameter sweep for variable detection of a sensor according to an exemplary embodiment of the present invention. Referring to FIG. 5, in the case where there is a signal carried on a channel according to the parameter sweep, the frequency-variable detecting unit 370 outputs a detected signal of constant amplitude, and otherwise, no signals.

Although it has been exemplified in FIG. 3 that the frequency-variable detecting unit 370 is implemented by the amplifier 371, the resonator (consisting of the variable condenser 373 and the coil 374) and the signal detector 372, this exemplary embodiment is not limited thereto. For example, the frequency-variable detecting unit 370 may be realized as a signal detector including a variable resonator. In this case, the frequency-variable detecting unit 370 may detect a signal only at a specific resonance frequency (channel) among varying resonance frequencies. That is, the frequency-variable detecting unit 370 operates only when a signal is entered into the frequency-variable detecting unit 370 while carried on the specific channel.

If there is any received signal carried on the channel, the frequency-variable detecting unit 370 outputs the detected signal of the received signal, but if no (for example, in a case where a noise signal only exists), the frequency-variable detecting unit 370 outputs no signals. This allows for improved sensitivity and more rapid determination on whether to use a channel in comparison with using a general variable channel filter. In addition, this may provide an advantage that may simultaneously perform determination on whether to use a channel and signal demodulation.

The digital processor 310 determines whether to use the channels on which the detected signal is carried depending on the result processed by the frequency-variable detecting unit 370 and selects a channel currently unused (i.e., a channel on which there is no signal outputted from the frequency-variable detecting unit 370) as a transmission channel. Data subjected to transmission is modulated by the oscillator 320 to comply with the frequency of the determined channel and then transmitted to the hub via the amplifier 330, the duplexer 340, and the antenna 350. In this case, since the data transmitted from the sensor generally has a low data rate, digital amplitude modulation such as OOK (On Off Keying) or ASK (Amplitude Shift Keying) may be employed as its modulation scheme. If so, an output signal from the sensor may be shaped as a digital pulse.

Transmission data outputted from the digital processor 310 may be packet-type digital data as shown in FIG. 6. Referring to FIG. 6, the transmission packet 600 may be implemented in the form of PPDU (Physical Protocol Data Unit) that includes data fields of a preamble 601, an SFD (Start of Frame Delimiter) 602, a PHR (PHY header) 603, and a PSDU (PHY Service Data Unit) 604.

The preamble 601 and the SFD 602 enable a packet symbol to be synchronized at a receiving side. The PHR 603 includes a length value of the PSDU 604 that is data information actually subjected to transmission.

It may be configured so that both the preamble 601 and the PSDU 604 are inevitably included in the transmission packet 600, but the SFD 602 or the PHR 603 is selectively included in the transmission packet 600. It should be noted that the data packet shown in FIG. 6 is merely an example and other various types of data packets are available.

FIG. 4 is a block diagram illustrating a detailed structure of a hub according to an exemplary embodiment of the present invention. Referring to FIG. 4, the hub according to this exemplary embodiment may include an antenna 410, a band pass filter 420, amplifiers 430 and 470, a channel filter bank 440, a channel detector bank 450, a plurality of low pass filters (“LPFs”) 460, and a digital processor 480.

As described above with reference to FIG. 3, data transmitted from the sensor through a specific channel within a band may be received and processed by the hub. The hub may be configured to spectrum-scan a plurality of channels included in the band to receive only a signal carried on a corresponding channel. Since the hub may have a further complicated structure in comparison with the sensor, the hub may be configured to have a separate receiver for each channel as shown in FIG. 3.

Among signals received by the antenna 410, only ones of a predetermined receiving frequency band pass through the band pass filter 420. The passed signals are inputted to the channel filter bank 440 via the amplifier 430.

The channel filter bank 440 may have filters (not shown) as many as the number of the channels divided in the band-Each filter performs filtering of only the signal of a corresponding channel among the input signals. The channel detector bank 450 may include a plurality of signal detectors (not shown), each allocated for each channel. The channel detector bank 450 receives a signal filtered correspondingly to each channel filter of the channel filter bank 440. The corresponding channel signal detected by the signal detector for each channel included in the channel detector bank 450 is inputted through the LPF 460 and the amplifier 470 to the digital processor 480.

The digital processor 480 analyzes the header (i.e. preamble 601) of the packet data received for each channel. If it is identified that the signal has a designated code, the digital processor 480 starts to receive and process the signal. If there is any signal received through the corresponding channel but the received signal does not have the designated code, the digital processor 480 discards the data packet.

As described above, the channel filter bank 440 and the channel detector bank 450 may be replaced by the frequency-variable detecting unit used for the sensor shown in FIG. 3.

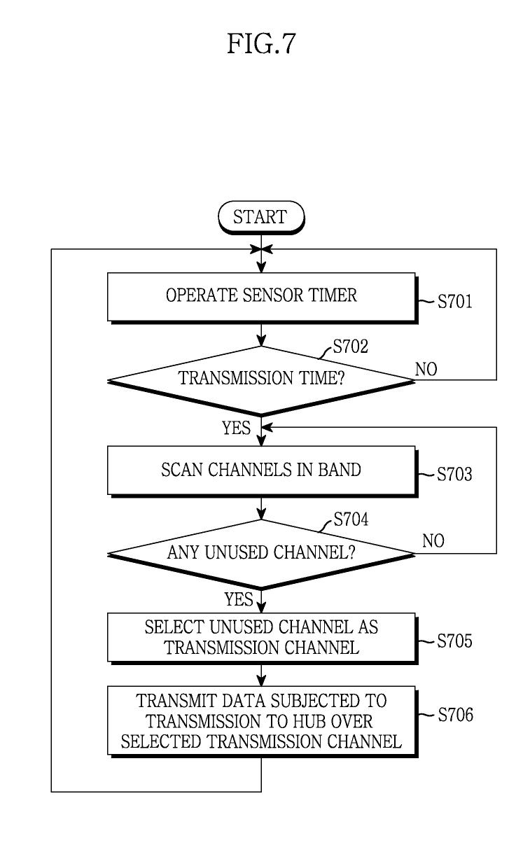

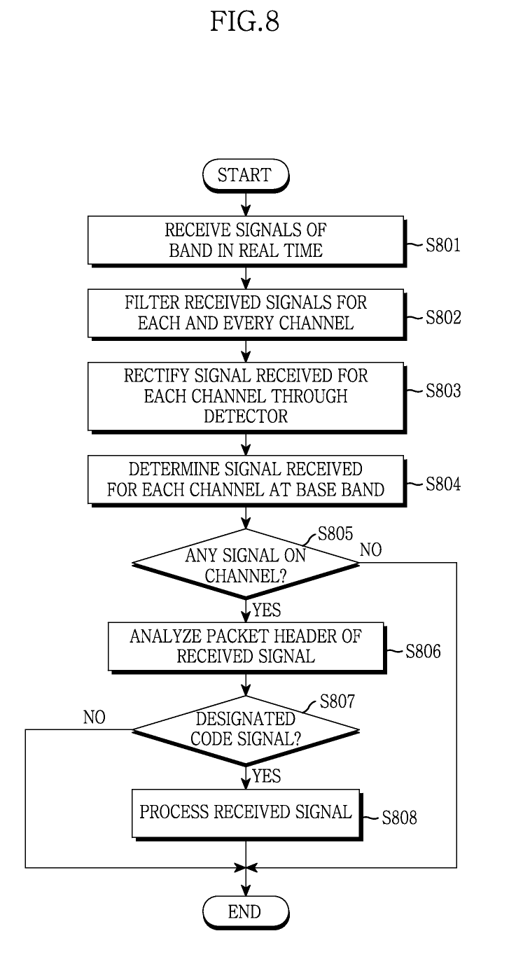

The operation of the sensor and hub according to exemplary embodiments will now be described with reference to FIGS. 7 and 8.

FIG. 7 is a flowchart illustrating a data transmission procedure in a sensor according to an exemplary embodiment of the present invention. Referring to FIG. 7, the timer included in the sensor firstly operates S701 to determine a time point when the data is to be transmitted S702. If the time point is reached, then it is identified by the spectrum sensing method according to the exemplary embodiment whether there is any channel available in a transmission band.

That is, a plurality of channels included in a band are sequentially scanned S703 to identify whether the channels are pre-occupied for use S704. If there is any channel available, then the channel is selected as a data transmission channel S705 and data is transmitted to a hub over the data transmission channel S706.

In this case, the scanning and identification of the available channel is conducted by the frequency-variable detecting unit according to the exemplary embodiment as described above.

Although it has been exemplified in FIG. 7 that the time point for data transmission is determined by the timer, the time point may be determined by any other methods. For example, the exemplary embodiment may be configured so that when the sensor receives a signal requesting data transmission from the hub, the sensor operates to transmit data to the hub. As another example, the exemplary embodiment may also be configured so that when the sensor satisfies a certain condition (for example, when a sensed value, such as temperature, exceeds a predetermined value), the sensor transmits the data to the hub.

FIG. 8 is a flowchart illustrating a data receiving procedure performed by a hub according to an exemplary embodiment of the present invention. Referring to FIG. 8, signals transmitted through a specific channel included in the band as shown in FIG. 7 is received and processed by the hub.

First of all, the hub receives the signals of a band in real time S801 and filters the received signals for each and every channel S802. Thereafter, the hub rectifies each signal filtered for each channel with the detector S803 and then determines the signal received for each channel at base band S804.

If it is determined that any signal is present on a channel S805, the packet header of the received signal is analyzed S806. If the analysis shows the signal is a valid communication signal S807, the hub starts to process the received signal S808, and otherwise ends the procedure.

As described above, an information collecting device such as the hub always receives the whole channels and collects in real time any information randomly transmitted from a plurality of transmission sensors. This type of sensor network may effectively apply for a case where body information such as the heart rate and body temperature transmitted from a temperature sensor and WBAN (Wireless Body Area Network), positional information, building monitoring information, or the like are transmitted to a hub that is an information collecting device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus for performing a local wireless communication using a frequency band, wherein at least a part of the frequency band is divided into a plurality of channels, the apparatus comprising:
a plurality of sensors, each sensor scanning each channel to identify whether each channel is used or not, selecting an unused channel as a data transmission channel, and transmitting data through the unused data transmission channel; and
at least one hub performing local wireless communications with the plurality of sensors at the frequency band, the hub receiving and processing the data transmitted from each sensor through each corresponding data transmission channel of the frequency band.

2. The apparatus of claim 1, wherein the sensor includes a frequency-variable detecting unit that generates a resonant frequency.

3. The apparatus of claim 2, wherein the sensor further includes a control unit for generating a control signal, and
wherein the frequency-variable detecting unit includes:
a resonator that variably generates the resonant frequency according to the control signal generated by the control unit; and
a signal detector that detects each channel corresponding to the resonant frequency generated by the resonator.

4. A local wireless communication method in which at least one hub performs local wireless communications with a plurality of sensors at a predetermined frequency band, the method comprising:
dividing at least a part of the frequency band into a plurality of channels;
when it reaches a time for one of the sensors to transmit data, scanning and spectrum-sensing each channel to identify a channel that is not used by the remaining ones of the sensors;
selecting the unused channel as a data transmission channel for said one of the sensors; and
transmitting data from said one of the sensors to the hub through the data transmission channel.

5. The method of claim 4, further comprising:
filtering a signal received by the hub at the frequency band for each channel; and
analyzing a header of packet data for each channel to receive and process the packet data when the packet data is identified to have a designated code.
